(19) United States
(12) Patent Application Publication
(10) Pub. No.: US 2012/0198620 A1
(43) Pub. Date: Aug. 9, 2012

(54) MOTORIZED CENTER WHEEL DEPLOYMENT MECHANISM FOR A PATIENT SUPPORT

(76) Inventors: David W. Hornbach, Brookville, IN (US); Edward J. Koors, Indianapolis, IN (US)

(21) Appl. No.: 13/355,057

(22) Filed: Jan. 20, 2012

Related U.S. Application Data
(60) Provisional application No. 61/440,666, filed on Feb. 8, 2011.

(51) Int. Cl. A61G 7/08

(52) U.S. Cl. 5/510

(57) ABSTRACT

A patient support is configured to support a person in at least a horizontal position. A propulsion device may be coupled to the patient support to facilitate movement of the patient support from one location to another. The propulsion device includes at least one wheel. A deployment mechanism moves the wheel between a storage position and a use position relative to the patient support. The deployment mechanism is motorized. The deployment mechanism uses a toggle force to initiate movement of the wheel from the storage position to the use position.

### CROSS-REFERENCES TO RELATED APPLICATIONS

This application claims the benefit of and priority to U.S. Provisional Patent Application Ser. No. 61/440,666 filed Feb. 8, 2011, which is incorporated herein by this reference in its entirety.

### BACKGROUND

This disclosure relates to patient supports, such as hospital beds and stretchers. More particularly, the present disclosure relates to a deployment mechanism for a propulsion system for a patient support. A propulsion system is a feature that can be provided with or added to a patient support to facilitate movement of the patient support. Propulsion systems can assist caregivers in moving the patient support from one location to another. Some propulsion systems may also be known as “auxiliary wheel,” “fifth wheel” or “center wheel” systems. The propulsion systems may be motorized (“powered”) or non-motorized (“non-powered”). Some examples of powered and non-powered patient support propulsion systems are disclosed in U.S. Pat. Nos. 5,348,326; 5,987,671; 6,257,608; 6,286,165; 6,330,926; 6,505,359; 6,588,523; 6,701,554; 6,749,034; 6,874,800; 6,877,772; 6,902,019; 7,011,172; 7,014,000; 7,021,407; 7,083,012; 7,195,253; 7,284,626; 7,407,024; and 7,828,092.

Additional features of the disclosure will become apparent to those skilled in the art upon consideration of the following detailed description when taken in conjunction with the accompanying drawings.

### SUMMARY

In accordance with one aspect of this disclosure, a patient support includes a plurality of casters, a frame to support a person in at least a horizontal position, the frame being supported by the casters, and a propulsion device coupled to the frame. The propulsion device facilitates movement of the patient support from one location to another. The propulsion device includes a wheel spaced from the casters, and a deployment mechanism coupled to the wheel. The deployment mechanism moves the wheel between a storage position in which the wheel is not in contact with a floor surface and a use position in which the wheel contacts the floor surface. The deployment mechanism includes a toggle mechanism, which applies a first toggle force in a first direction to move the wheel to the storage position, and applies a second toggle force in a second direction to move the wheel to a position in between the storage position and the use position.

The patient support may include a motor configured to drive rotation of the wheel and a motor configured to drive the toggle mechanism. The toggle mechanism may include a deployment drive and a switch coupled to the deployment drive, where the switch is configured to stop operation of the deployment drive before the wheel moves to the use position. The deployment drive may include a gear motor. The deployment drive may include a foot pedal.

The deployment mechanism may include a motor, a linkage coupled to the motor and to the wheel, and a gas spring coupled to the linkage. The deployment mechanism may include a yoke coupled to the linkage between the motor and the wheel. A slot may be defined in the yoke. A follower may be coupled to the linkage and movably positioned in the slot.

According to another aspect of this disclosure, a deployment mechanism for a patient support propulsion device includes a motor, a first link pivotably coupled to an output shaft of the motor, a yoke pivotably coupled to the first link, a second link coupled to the yoke, and a gas spring coupled to the second link. The deployment mechanism may include a slot defined in the yoke and a follower movably disposed in the slot. The deployment mechanism may include a rotating shaft coupled to the follower, where the follower rotates with the shaft. A first end of the yoke may be coupled to the first link and a second end of the yoke may be coupled to and rotatable about the shaft. The deployment mechanism may include a gas spring, where a first end of the second link rotates with the shaft and a second end of the second link is coupled to the gas spring.

According to a further aspect of this disclosure, a propulsion system for use with a patient support comprising a frame configured to support a person in at least a horizontal position, includes a propulsion device couplable to a frame of a patient support configured to support a person in at least a horizontal position. The propulsion device includes a wheel and a deployment mechanism coupled to the wheel. The deployment mechanism moves the wheel between a storage position in which the wheel is not in contact with a floor surface and a use position in which the wheel contacts the floor surface. The deployment mechanism includes a motorized toggle mechanism, which applies a first toggle force in a first direction to move the wheel to the storage position, and applies a second toggle force in a second direction to initiate but not complete movement of the wheel from the storage position to the use position.

The propulsion system may include a gas spring coupled to the toggle mechanism, where the gas spring is configured to complete the movement of the wheel from the storage position to the use position. The propulsion system may include a yoke configured to unload the deployment mechanism before the wheel reaches the use position.

The deployment mechanism may be configured to move the wheel from the storage position to a position intermediate the storage position and the use position. The deployment mechanism may be configured to move the wheel from the intermediate position to the use position. The deployment mechanism may activate a motor to move the wheel from the storage position to the intermediate position, and may deactivate the motor to move the wheel from the intermediate position to the use position.

Additional features and advantages of the present invention will become apparent to those skilled in the art upon consideration of the following detailed description of the presently perceived best mode of carrying out the invention.

### BRIEF DESCRIPTION OF THE DRAWINGS

The detailed description particularly refers to the accompanying figures in which:

FIG. 1 is a perspective view of a patient support with a propulsion system coupled thereto;

FIG. 2 is a top perspective view of the propulsion system of FIG. 1, showing the wheels and the deployment mechanism in a “down” position;

FIG. 3 is a side view of the propulsion system of FIGS. 1-2, with portions of the housing omitted for clarity, showing the wheels and the deployment mechanism in an “up” position; and

FIG. 4 is a side view of the propulsion system of FIGS. 1-3, with portions of the housing and the deployment drive omitted for clarity, showing the wheels and the deployment mechanism in a “down” position.

### DETAILED DESCRIPTION OF THE DRAWINGS

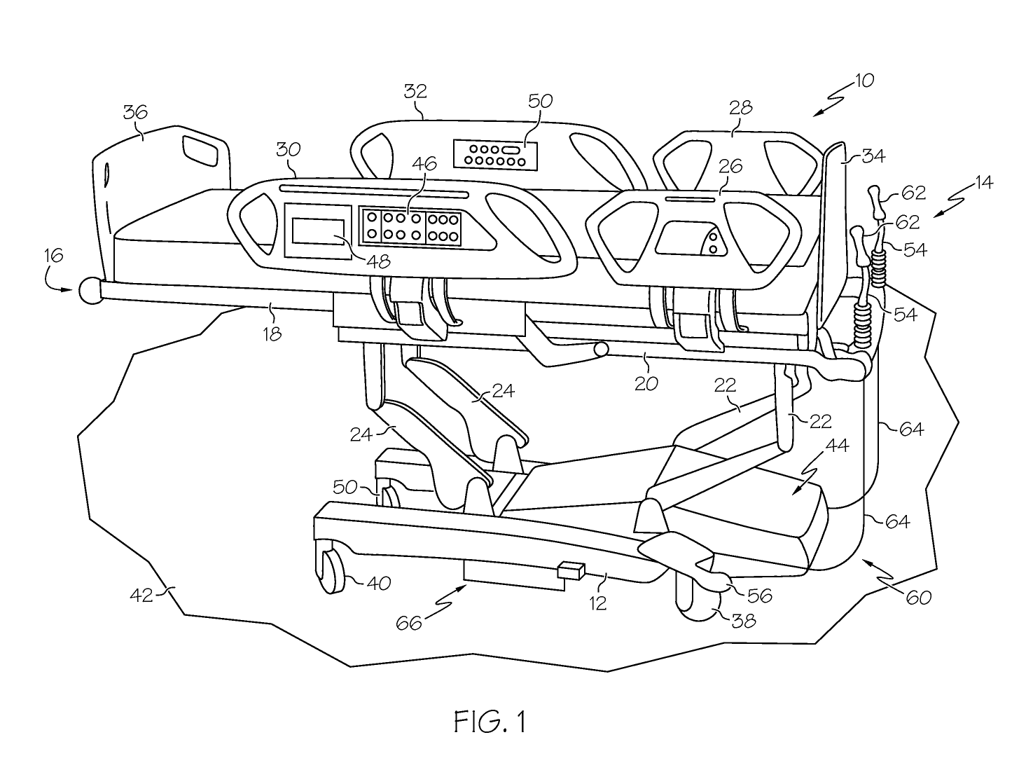

A patient support 10 is shown in FIG. 1. The patient support 10 is designed to support a person in a seated or a laying-down position. The patient support 10 is of a type that is typically used in hospitals and other facilities in which health care is provided. More specifically, the patient support 10 is of a type that can support a person in a variety of positions, including a laying-down position and a seated position, and includes a number of features that are controlled electronically by an on-board bed control unit (BCU) 44. However, this disclosure applies to any type of bed or similar structure, including but not limited to stretchers and other patient support structures, whether or not all of the features of the illustrated patient support 10 are included in such structure, and whether or not such patient support structure includes other features not mentioned herein.

FIG. 1 shows the patient support 10 in a flat or horizontal position, which can support a person in a laying down position. The patient support 10 has a head end 14 and a foot end 16 longitudinally spaced from the head end 14.

The patient support 10 includes a base 12. The base 12 is movably supported by a pair of head end casters 48 (the view of one of the head end casters 38 being obstructed in FIG. 1), and a pair of foot end casters 40. The casters 38, 40 each include one or more wheels that support the patient support 10 relative to a floor 42 or other surface, for movement in one or more directions. Movement of at least the head end casters 38 may be controlled by a brake 56. The brake 56 may have a number of positions, such as a braking position, in which the caster 38 is restricted from movement, a steer position, in which the caster 38 may swivel, and an unbraked position, in which the caster 38 can roll freely. Some examples of suitable casters and braking systems for patient supports are disclosed in U.S. Pat. Nos. 6,321,878; 6,473,921; 6,865,775; 6,874,800; 7,014,000; 7,302,717; 7,346,942; and 7,698,760.

A frame 20 is coupled to and supported by the base 12. A lift mechanism, which includes a pair of head end lift arms 22 and a pair of foot end lift arms 24, is coupled to the base 12 and to the frame 20. The lift arms 22, 24 operate to raise, lower, and tilt the frame 20 relative to the base 12. Movement of the lift arms 22, 24 is driven by a pair of actuators (not shown).

A deck 18 is coupled to and supported by the frame 20. The deck 18 supports a mattress 52, which, in turn, may support a person positioned thereon. The deck 18 has a number of sections some of which are rotatable to, as noted above, allow the patient support 10 to assume a variety of positions including a horizontal position, a chair position, and a number of positions intermediate the horizontal and chair positions.

The patient support 10 has a number of siderails, namely opposing head end siderails 26, 28 and opposing foot end siderails 30, 32, a head endboard 34, and a foot endboard 36. Also, a pair of handles 54 is supported by the frame 20.

As noted above, the patient support 10 has one or more electronically-controllable bed functions or features, which are controlled and operated by the BCU 44. Such features may include adjusting the position, length, or width of the bed, raising, lowering, or pivoting a section of the bed, weighing a person positioned on the bed, inflating, deflating, or adjusting inflation in one or more sections of the mattress, laterally rotating a person positioned on the bed, and/or other automated features.

The electronically-controllable features and functions of the patient support 10 may be activated, configured, and deactivated by user inputs that are translated into electrical signals and forwarded to the BCU 44 by input devices or input-output devices, which include, in the illustrated embodiment, caregiver bed hardpanel controls 46, a caregiver user interface 48, and patient hardpanel controls 50. The hardpanel controls 46, 50 (e.g. buttons, switches, dials, slides, levers or the like) and the caregiver user interface 48 (e.g. graphical user interface and/or touchscreen) permit certain users, namely caregivers, technicians or other staff persons, and persons situated on the bed, to activate and deactivate the electronically-controllable features of the patient support 10 (e.g. by applying physical contact to the selected control).

The controls 46, 48, 50 each include circuitry that conveys voltage generated (e.g., in response to contact thereon) to the BCU 44. In the illustrated embodiment, the caregiver hardpanel controls 46 and the caregiver user interface 48 are mounted to the outwardly facing side of at least one of the siderails 30, 32 (i.e., facing away from the mattress), while the patient hardpanel controls 50 are mounted to an inwardly facing side of at least one of the siderails 30, 32 (i.e. facing toward the mattress). However, this disclosure contemplates that the controls 46, 48, 50 may be placed in any suitable location that is accessible to the desired users. For example, some controls may be provided on a wall-mounted device or a remote control device.

Generally speaking, the BCU 44 includes one or more microprocessors or microcontrollers and electrical and/or computer circuitry mounted on one or more substrates (e.g. printed circuit boards), which are typically located in a housing that is mountable to the patient support 10. In the illustrated embodiment, the BCU 44 is mounted to the base 12. However, the BCU 44 may be placed in any suitable location on the bed or elsewhere.

In many instances, the BCU 44 receives electrical signals from a number bed function modules or devices, including the controls 46, 48, 50. The BCU 44 and other components of the electrical control system of the patient support 10 are arranged according to a suitable system to allow unidirectional and/or bidirectional electrical communication among these and other components as required to execute a given feature or function of the patient support 10.

Among other things, the BCU 44 processes inputs from the various electronically controlled components and modules of the patient support 10, stores data in and retrieves data from memory, and executes computer logic to control the operation of the electronically-controllable features of the patient support 10. The BCU 44 includes one or more processors that determine the appropriate action (e.g. by executing computerized processes or algorithms using information contained in the received signals and/or other information, which may be stored in a memory of the BCU 44). For example, if the BCU 44 determines (e.g. through the execution of logic) that an electronically-controlled feature is to be actuated, the BCU 44 sends a control signal to the electronically-controlled feature via a signal path (not shown).

The signal path may include a wired or wireless connection, or may be connected to an electronic network, such as an Ethernet network, which may be configured according to a TCP/IP or other suitable electronic communications protocol. In general, the signal path is configured with as many signal paths therein as may be needed to accomplish the sending and receiving of data and/or instructions between or among the various electronically-controlled features of the patient support 10.

It is contemplated that the logic, functions and processes identified herein as being part of the BCU 44 may be implemented as one or more distributed modules that are in communication with the BCU 44. Also, the BCU 44 itself may comprise a number of different units or sub-modules rather than being contained in a single housing.

In operation, a caregiver or other staff person can move the patient support 10 by pushing on the frame 20 or on one or both of the handles 54, to cause the casters 38, 40 to move along the floor 42.

A propulsion system 60 can provide assistance with the movement of the patient support 10, to, for example, relieve a person from having to provide all of the force and energy necessary to move patient support 10 between locations in a care facility.

The propulsion system 60 may include a pair of input devices 62, a pair of signal paths 64, and a propulsion device 66. One input device 62 is coupled to each handle 54, respectively. Similarly to the controls 46, 48, 50, the input devices 62 output voltage (e.g. in response to a force applied thereto, movement or contact), which signals the BCU 44 to control the operation of the propulsion device 66. For example, movement of an input device 62 in one direction may cause the propulsion device 66 to move the patient support 10 in a forward direction at a certain speed, while movement of the input device 62 in the opposite direction may cause the propulsion device 66 to move the patient support 10 in a reverse direction at a certain speed. Alternatively or in addition, the input devices 62 may be used to deploy the propulsion system 60. Some examples of propulsion system input devices are disclosed in one or more of the patents listed above.

The propulsion device 66 includes a housing 68, which is mounted to the base 12 of the patient support 10 by bolts, welding, or other suitable fastening methods. The housing 68 includes a pair of vertical walls 70, 72, which extend transversely across the width of the base 12 when the propulsion device 66 is mounted to the patient support 10. In between the walls 70, 72, there are a number of walls 74, 76, 78, which support components of the propulsion device 66 and extend longitudinally along the length of the base 12 when the propulsion device 66 is mounted to the patient support 10. The walls 70, 72, 74, 76, 78 are supported by bottom panels 84, 86.

The propulsion device 66 further includes, in the illustrated embodiment, a pair of wheels 80, which may or may not be motorized, and a deployment mechanism 82. In other embodiments, a single wheel or any suitable number of wheels 90 may be provided. A space between the bottom panels 84, 86 defines an area in which the wheels 80 are located.

In motorized versions of the propulsion device 66, the wheels 80 are driven by a drive motor, which is coupled to at least one power supply. The drive motor is coupled to the BCU 44 or directly to the input devices 62 via the signal paths 64, to receive speed and/or direction control signals therefrom. The drive motor and power supply, which power the wheels 80, are not part of the deployment mechanism 82 and are therefore omitted from the drawings for clarity. Some examples of drive systems for motorized versions of the propulsion device 66 are disclosed in one or more of the patents listed above.

In general, the deployment mechanism 82 controls whether the wheels 80 are or are not used to assist with movement of the patient support 80. The deployment mechanism 82 provides for storage of the wheels 80 in a storage position in which the wheels 80 are spaced apart from the floor 42, for movement of the wheels from the storage position to a use position, in which the wheels 80 are engaged with the floor 42, and for movement of the wheels 80 from the use position to the storage position. The deployment mechanism 82 includes a toggle feature, described below, which enables the wheels 80 to assume a position in between the storage position and the use position.

In some embodiments, action of the deployment mechanism 82 may be taken in response to signals from the input devices 62, or conditioned upon the mode of the casters 38, 40 or the brake 56 being in a position in which the casters 38, 40 are braked. To accomplish this, the BCU 44 may receive an electrical signal from the input devices 62 and/or the caster or casters 38, 40 (e.g., indicating the caster mode) and/or the brake 56 (e.g. indicating the brake position). Based on this input, the BCU 44 may send a control signal to the deployment mechanism 82 (e.g., to move the wheels from the storage position to the use position or vice versa). Some examples of caster/brake mode detection systems are disclosed in one or more of the patents listed above.

Additionally, the deployment mechanism 82 may be configured to detect whether the wheels 80 are in the storage position or the use position, and to provide an electrical signal indicating the position of the wheels 80 to the BCU 44 or directly to the drive motor, so as to prevent the drive motor from powering the wheels 80 when the wheels 80 are not in the use position and to permit the drive motor to power the wheels 80 when the wheels 80 are in the use position. Some examples of such a detection mechanism are disclosed in one or more of the patents listed above.

In some embodiments, the deployment mechanism 82 may have its own control unit, which communicates directly with the input devices 62, the casters 38, 40 and/or the brake 56, the drive motor, and the input devices 62, such that the BCU 44 may have little or no involvement with the functionality of the propulsion system 60.

The deployment mechanism 82 includes a deployment drive 88, which is mounted to the wall 76. The deployment drive 88 is a gear motor or other device of similar function. For example, in other embodiments, the deployment drive may include a foot pedal mechanism such as is described in U.S. Pat. No. 5,348,326, which is incorporated herein by this reference.

The deployment drive 88 drives rotation of an output shaft 90 in the directions of a bidirectional arrow 92. A link 94 is coupled to and rotates with the output shaft 90. A pivot coupler 96 couples the link 94 to an arm 98. When the link 94 rotates in one of the directions indicated by the bidirectional arrow 92, the arm translates in one direction, and rotation of the link 94 in the other direction indicated by the bidirectional arrow 92 translates the arm 98 in the opposite direction. For example, when the link 94 rotates in a counter-clockwise direction, the proximal end 160 of the link 98 similarly rotates in the counter-clockwise direction, thereby translating the distal end 162 of the link 98 in the direction of the arrow 150.

A pivot coupler 102 pivotably couples a first end 106 of a yoke 104 to the distal end 162 of the arm 98, such that the yoke 104 pivots about the pivot coupler 102 relative to the arm 98 in the directions indicated by the bidirectional arrow 134. A second end 108 of the yoke 104 is coupled to and rotates about a shaft 144 in the directions indicated by the bidirectional arrow 146.

Translation of the arm 98 also rotates the link 142 in the directions indicated by the bidirectional arrow 146. The link 142 is coupled to and pivots with the shaft 144, so that the shaft 144 also rotates in the directions indicated by the bidirectional arrow 146. One end 112 of the shaft 144 is coupled to the wall 78, and the other end 114 of the shaft 144 is coupled to a middle portion 116 of a link 120. The link 120 rotates with the shaft 144 in the directions indicated by the bidirectional arrow 146. Also, a first end 136 of the link 120 is coupled to an axle 110. The axle 110 rotatably supports the wheels 80.

A pair of gas springs 122 is coupled to a second end 118 of the link 120. Each gas spring 122 has a substantially similar structure, so only one will be described. A first end 124 of a pressure tube of the gas spring 122 is pivotably mounted to the wall 70. A rod 128 extends and retracts from a second end 126 of the pressure tube of the gas spring 122. A head 130 is coupled to a distal end 132 of the rod 128. The head 130 of each of the gas springs 122 is pivotably coupled to the second end 118 of the link 120.

A slot 138 is defined adjacent the first end 106 of the yoke 104. A first end 152 of the link 142 rotates with the shaft 144 and relative to the yoke 104. A follower 140 extends substantially perpendicularly from a second end 154 of the link 142 through the slot 138.

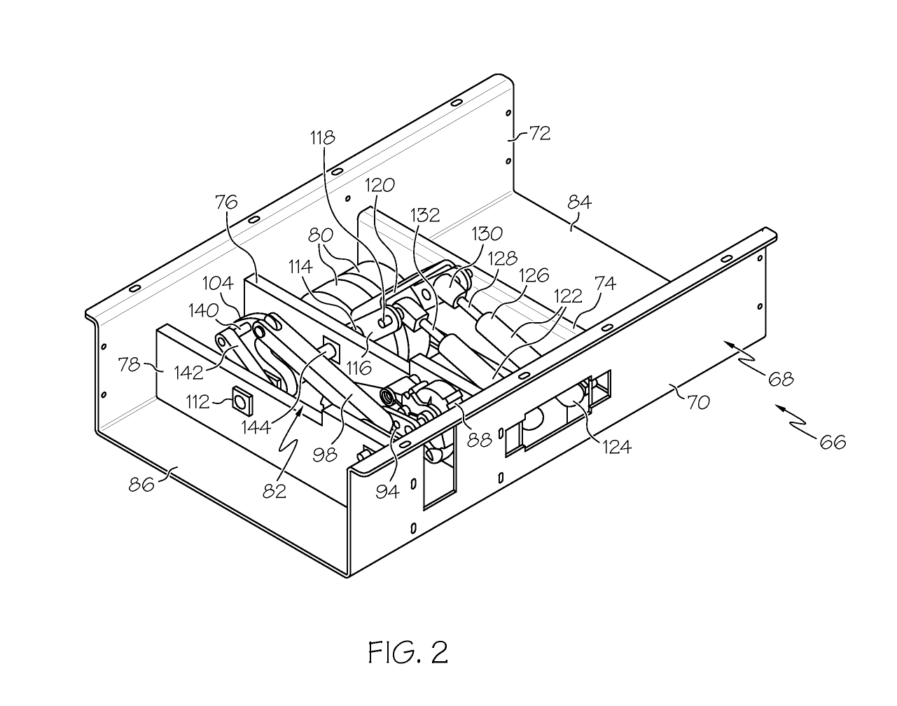

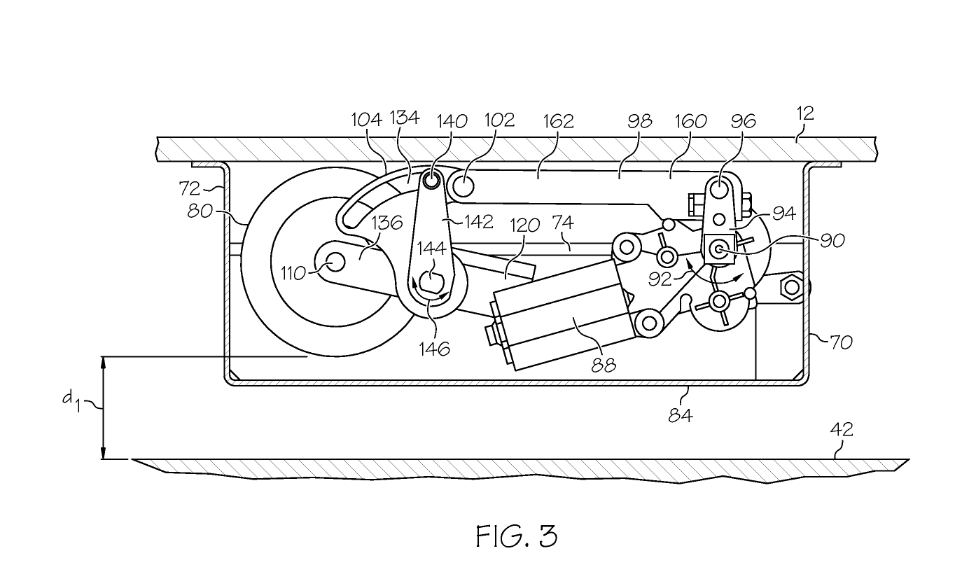

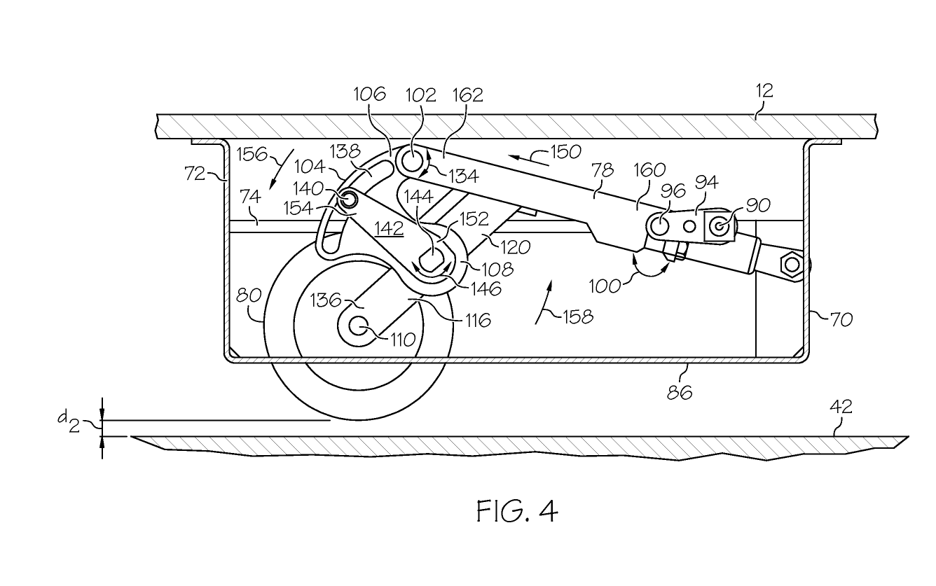

FIGS. 1 and 3 show the wheels 80 in the storage position, while FIGS. 2 and 4 show the wheels 80 in a “down” position, which is reached prior to the use position (in which the wheels 80 are contacting the floor 42). In the storage position, the wheels 80 are positioned a distance d₁ above the floor 42.

To move the wheels 80 from the storage position to the down position, the deployment drive 88 drives rotation of the output shaft 90, and thus the link 94, a first amount in a counter-clockwise direction, where the first amount may be programmed or determined based on experimentation and may vary according to the requirements of a particular design or configuration of the propulsion system 60 and/or the patient support 10. Rotation of the link 94 causes movement of the arm 98 in the direction 150. As a result, the yoke 104 pivots about the shaft 144, and the link 142 rotates the shaft 144, in the direction 156.

Pivoting of the link 142 pivots the shaft 144 in a counter-clockwise direction, causing the second end 118 of the link 120 to rotate in the direction of the arrow 158. As a result, the heads 130 of the gas springs 122 are raised above the main pivot or shaft 144 and the wheels 80 move toward the floor 42.

A limit switch (not shown) is coupled to the deployment drive 88. The limit switch is configured (e.g. with a pre-programmed end of travel) to stop the operation of the deployment drive 88 before the wheels 80 contact the floor 42 (e.g., in the down position shown in FIG. 4). When the deployment drive 88 stops rotating the output shaft 90, the yoke 104 no longer pivots about the shaft 144 and the link 142 no longer drives the pivoting of the shaft 144.

Instead, the gas springs 122 push the second end 118 of the link 120 in the direction of the arrow 150 (e.g. the rods 128 extend away from the pressure tubes 124). This movement of the link 120 rotates the shaft 144 further in the counter-clockwise direction, which causes the follower 140 to travel in the direction of the arrow 156 within the slot 138. As a result, the gas springs 122, not the deployment drive 88, cause the wheels 80 to travel the final distance d₂ to the floor 42 (where d₂ is less than d₁). In other words, the deployment drive 88 does not apply the load (i.e. wheels 80) to the floor 42, but only “toggles” the state of the deployment mechanism 82 from “up” (FIGS. 1 and 3) to “down” (FIGS. 2 and 4).

To move the wheels 80 from the use position to the storage position, the deployment drive 88 drives rotation of the output shaft 90, and thus the link 94, a second amount in a clockwise direction, where the second amount may be programmed or determined based on experimentation and may vary according to the requirements of a particular design or configuration of the propulsion system 60 and/or the patient support 10. Rotation of the link 94 causes movement of the arm 98 in the direction opposite the arrow 150. As a result, the yoke 104 pivots about the shaft 144, and the link 142 rotates the shaft 144, in the clockwise direction.

Pivoting of the link 142 in a clockwise direction pivots the shaft 144 in a clockwise direction, causing the second end 118 of the link 120 to rotate in a direction opposite the arrow 158. As a result, the heads 130 of the gas springs 122 are lowered below the main pivot or shaft 144 and the wheels 80 move upwardly away from the floor 42 to the storage position.

Although the invention has been described in detail with reference to illustrative embodiments, variations and modifications exist within the scope and spirit of the invention as described and defined in the following claims.

1. A patient support, comprising:
a plurality of casters,
a frame configured to support a person in at least a horizontal position, the frame being supported by the casters,
a propulsion device coupled to the frame and configured to facilitate movement of the patient support from one location to another, the propulsion device comprising a wheel spaced from the casters, and
a deployment mechanism coupled to the wheel, the deployment mechanism being configured to move the wheel between a storage position in which the wheel is not in contact with a floor surface and a use position in which the wheel contacts the floor surface, the deployment mechanism comprising a toggle mechanism, which applies a first toggle force in a first direction to move the wheel to the storage position, and applies a second toggle force in a second direction to move the wheel to a position in between the storage position and the use position.

2. The patient support of claim 1, comprising a first motor configured to drive rotation of the wheel and a second motor configured to drive the toggle mechanism.

3. The patient support of claim 1, wherein the toggle mechanism comprises a deployment drive and a switch coupled to the deployment drive, wherein the switch is configured to stop operation of the deployment drive before the wheel moves to the use position.

4. The patient support of claim 3, wherein the deployment drive comprises a gear motor.

5. The patient support of claim 3, wherein the deployment drive comprises a foot pedal.

6. The patient support of claim 1, wherein the deployment mechanism comprises a motor, a linkage coupled to the motor and to the wheel, and a gas spring coupled to the linkage.

7. The patient support of claim 6, comprising a yoke coupled to the linkage between the motor and the wheel.

8. The patient support of claim 7, comprising a slot defined in the yoke.

9. The patient support of claim 8, comprising a follower coupled to the linkage and movably positioned in the slot.

10. A deployment mechanism for a patient support propulsion device, the deployment mechanism comprising:
a motor,
a first link pivotably coupled to an output shaft of the motor,
a yoke pivotably coupled to the first link,
a second link coupled to the yoke, and
a gas spring coupled to the second link.

11. The deployment mechanism of claim 10, comprising a slot defined in the yoke and a follower movably disposed in the slot.

12. The deployment mechanism of claim 11, comprising a rotating shaft coupled to the follower, wherein the follower rotates with the shaft.

13. The deployment mechanism of claim 12, wherein a first end of the yoke is coupled to the first link and a second end of the yoke is coupled to and rotatable about the shaft.

14. The deployment mechanism of claim 13, comprising a gas spring, wherein a first end of the second link rotates with the shaft and a second end of the second link is coupled to the gas spring.

15. A propulsion system for a patient support comprising a frame configured to support a person in at least a horizontal position, the propulsion system comprising:
a propulsion device couplable to a frame of a patient support configured to support a person in at least a horizontal position, the propulsion device comprising a wheel, and
a deployment mechanism coupled to the wheel, the deployment mechanism being configured to move the wheel between a storage position in which the wheel is not in contact with a floor surface and a use position in which the wheel contacts the floor surface, the deployment mechanism comprising a motorized toggle mechanism, which applies a first toggle force in a first direction to move the wheel to the storage position, and applies a second toggle force in a second direction to initiate but not complete movement of the wheel from the storage position to the use position.

16. The propulsion system of claim 15, comprising a gas spring coupled to the toggle mechanism, wherein the gas spring is configured to complete the movement of the wheel from the storage position to the use position.

17. The propulsion system of claim 15, comprising a yoke configured to unload the deployment mechanism before the wheel reaches the use position.

18. The propulsion system of claim 15, wherein the deployment mechanism is configured to move the wheel from the storage position to a position intermediate the storage position and the use position.

19. The propulsion system of claim 18, wherein the deployment mechanism is configured to move the wheel from the intermediate position to the use position.

20. The propulsion system of claim 19, wherein the deployment mechanism activates a motor to move the wheel from the storage position to the intermediate position, and deactivates the motor to move the wheel from the intermediate position to the use position.
